(19) United States
(12) Patent Application Publication
(10) Pub. No.: US 2026/0168488 A1
(43) Pub. Date: Jun. 18, 2026

(54) METHOD FOR OPERATING A DIRECTION-OF-ROTATION SENSORLESS ELECTRIC MOTOR

(71) Applicant: Schaeffler Technologies AG & Co. KG, Herzogenaurach (DE)

(72) Inventors: Erhard Hodrus, Achern (DE); Christian Eberle, Bühl (DE); Alexander Rösch, Achern (DE)

(21) Appl. No.: 19/099,225

(22) PCT Filed: Jul. 7, 2023
(86) PCT No.: PCT/DE2023/100514

§ 371 Date: Jan. 28, 2025

(30) Foreign Application Priority Data
Aug. 2, 2022 (DE) 102022119336.5

(51) Int. Cl. F04B 49/10; F04B 49/22; H02P 6/18

(52) U.S. Cl. CPC F04B 49/103; F04B 49/22; H02P 6/183; F04B 2203/0209

(57) ABSTRACT

A method of operating a direction-of-rotation sensorless electric motor comprising a stator and a rotor, injected signals being used to determine rotational speeds of the electric motor, is characterized in that the rotational direction of the electric motor is determined and defined measures are taken if an unwanted rotational direction is actually determined or if an unwanted rotation direction is mistakenly determined.

### CROSS-REFERENCE TO RELATED APPLICATION

The present application is the U.S. National Phase of PCT Patent Application Number PCT/DE2023/100514, filed on Jul. 7, 2023, which claims priority to German Patent Application Number 10 2022 119 336.5, filed Aug. 2, 2022, the entire disclosures of which are incorporated by reference herein.

### TECHNICAL FIELD

The disclosure relates to a method of operating a direction-of-rotation sensorless electric motor having a stator and a rotor including determining the rotational direction of the electric motor and implementing defined measures when an unwanted rotational direction is determined or if an unwanted rotational direction is mistakenly determined.

The area of application of the disclosure is speed-directionally fixed electric motor drives, such as pump drives, actuator drives or traction electric motors for hybrid or fully electric drives in vehicles

### BACKGROUND

When an electric motor is operated without direction-of-rotation sensors, the rotor position sensor, which is usually used to determine the current angle of the rotor, is omitted. Current sensor signals and measured or estimated phase voltages are used to determine the rotor position and speed of the motor via a model.

Below a rotational speed threshold of the absolute rotational speed, it is necessary to feed in what are termed injected signals, which support the identification of the rotor position and the speed in this rotational speed range.

Starting with a stationary rotor, the rotor position must be determined by an initialization routine. With the injection methods, the motor can be operated in the lower rotational speed range until, for example, a switch to a model-based sensorless algorithm takes place.

The initial rotor position can be determined by specifying an alternating voltage excitation, a high-frequency oscillation in d-and q-voltage, for a certain number of points on a voltage circuit path, in which the exciting voltage amplitude leads to a resulting current amplitude. Due to the d-q coordinates, an ellipse in the d-q plane must be formed in the case of a circular excitation in the voltage in the current. The main axis of the ellipse corresponds to the d-direction. This direction of the main axis describes the initial value of the rotor position.

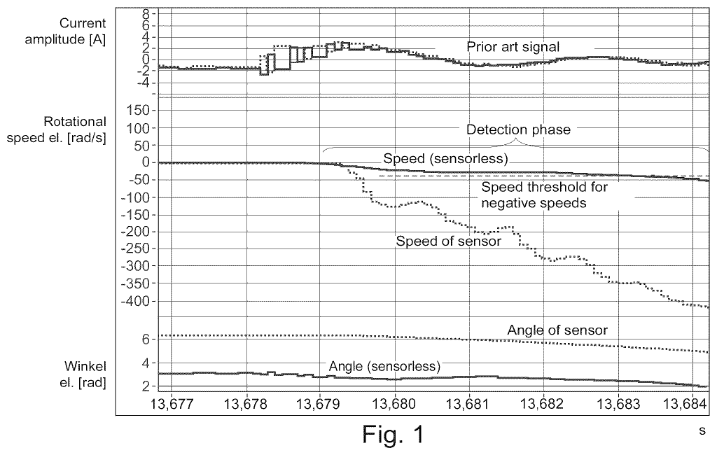

In the as yet unpublished German patent application DE 10 2022 110 304.8, it is proposed to find the longer main axis of the ellipse, which corresponds to the d-axis, by means of an iterative controller approach. By applying the injected signal on the voltage, a current can be measured. However, this is not transformed into the notional d-direction, but into the notional d−45° direction and notional d+45° direction (see FIG. 1, top, “prior art signal”). This allows significantly larger amplitudes in the current to be achieved compared to an evaluation of the currents in d-and q-direction, where the current in q-direction disappears when the real d-axis is found. This makes detection more robust against disturbances, and especially in dynamic situations. The amplitude of the injected signal is then determined using bandpass filtering and the two values for +/−45° are compared. The assumed angle is then corrected so that the two amplitudes in the direction +45° and −45° become equal (see FIG. 1, top, “prior art signal”). The correction is chosen in such a way that the longer semi-axis is found, i.e., the d-axis. If the sign is reversed during the correction, the algorithm finds the shorter semi-axis, i.e., the q-axis. With this approach, not only can the initial angle be found, but the electric motor can and will be operated with it.

In contrast to buried magnets, the inductances Ld and Lq of bonded magnets are more similar to each other. The ellipse is then not so pronounced and resembles more of a circle.

After a special situation, such as requesting open terminals or an active short circuit, the actuator must be reinitialized because no injected signal can be provided during this time. This situation may cause a possible so-called 180° error, which was resolved during the initial initialization, to occur again. It cannot be ruled out that the 180° error may be caused by external interference. If the 180° error occurs, the motor would start rotating in the wrong direction. Further explanations of the 180° error can be found, for example, in the as yet unpublished German patent application DE 10 2022 103 221.3.

The sensorless operation of a permanent magnet-activated synchronous machine must be carried out with an injected signal at low absolute rotational speeds. However, the injected signal can also be used in the whole working area, as shown, for example, in the as yet unpublished German patent application DE 10 2022 118 125.1. The anisotropy of the motor is evaluated because the inductances in the q and d directions are different (L_q not equal to L_d). Especially in small motors, the magnets are often glued on, so that the differences in inductance are small.

If the inductances are too similar at an operating point or if a special situation occurs in which, for example, the output stages are switched off for a short time (active short circuit or open terminals), a very rare and therefore rather spontaneous change in orientation in the system can occur, because the electric motor unintentionally rotates in the wrong direction, either actually or only apparently, i.e., not actually in reality, due to an error in determining the direction of rotation resulting from the special situation.

### SUMMARY

The disclosure is based on the object that the unwanted, improbable but possible change of orientation in the system, namely an actual or simply notional reversal of the direction of rotation of a system that is essentially fixed in direction of rotation, due to an electric motor that is unintentionally actually or simply notionally rotating in the wrong direction, should be detected as quickly as possible by a method in the sense of a diagnosis, so that defined, suitable measures can be initiated.

This object is achieved by a method having the features according to claim 1.

The method according to the disclosure for operating a direction-of-rotation sensorless electric motor having a stator and a rotor, injected signals being used to determine rotational speeds of the electric motor, therefore provides that the rotational direction of the electric motor is determined and defined measures are taken if an unwanted rotational direction is actually determined or if an unwanted rotational direction is mistakenly determined.

In a preferred embodiment, it is provided that the desired rotational direction is detected when positive rotational speed values are determined.

In a further preferred embodiment, it is provided that an unwanted rotational direction is detected if negative speed values are present during a detection phase of defined duration and if the rotational speed values fall below a defined negative speed threshold during the detection phase.

In a further preferred embodiment, it is provided that the rotational direction of the electric motor is determined immediately after the occurrence of a special situation.

In a further preferred embodiment, it is provided that there is a special situation when an output stage of the electric motor is switched off or when an anisotropy problem occurs.

In a further preferred embodiment, it is provided that there is a special situation when a short circuit occurs or when an active short circuit occurs or when open terminals occur.

After a special situation, such as requesting open terminals or an active short circuit, the electric motor must be reinitialized because no injected signal can be provided during this time.

In a further preferred embodiment, it is provided that a defined measure is an active short circuit.

In a further preferred embodiment, it is provided that a defined measure is the defined closing of valves in a hydraulic system.

In this way, a rotation in the wrong direction of an electric motor can be detected very quickly and appropriate defined measures can be initiated immediately before higher-level software strategies initiate measures that would or could have undesirable or even dangerous consequences.

Further advantages and advantageous configurations of the disclosure are the subject of the following figures and the description thereof.

### BRIEF DESCRIPTION OF THE DRAWING

In detail, in the figures:

FIG. 1
Top: shows the Prior art: By applying the injected signal on the voltage, a current can be measured. However, this is not transformed into the notional d-direction, but into the notional d−45° (line with dashes) direction and notional d+45° (line without dashes) direction.
Center: shows a method according to the disclosure for detecting a rotational direction error of an electrically operated pump motor in a hydraulic system.
Bottom: shows a rotor angle of a direction-of-rotation sensorless electric motor with having a stator and a rotor, injected signals being used to determine the rotor angle.

### DESCRIPTION OF PREFERRED EXEMPLARY EMBODIMENTS

FIG. 1, Center, shows the method according to the disclosure for detecting a rotational direction error, for example a 180° error, of an electrically operated pump motor in a hydraulic system.

In a special system such as a hydraulic pump, the rotational direction is always the same; the pump's electric motor is fixed in the direction of rotation. The resulting pressure is directed to specific consumers via valves.

The observation of the rotational direction can thus be evaluated as a trigger for the detection of a spontaneous, improbable change in the orientation of the hydraulic pump system. The rotational direction is determined with sensorless control and is often evaluated in the higher-level rotational speed controller.

The situation is similar with a rotor of a hybrid traction electric motor, for example of a P1 hybrid vehicle, which is connected in a rotationally fixed manner to an internal combustion engine by means of a shaft. If the traction electric motor were to start to move the combustion engine from a standstill in the wrong rotational direction, this would be detected by a monitoring routine to protect the combustion engine and, as a protective measure, at least the traction electric motor would be stopped.

However, these monitoring routines would only respond later than the method according to the disclosure, so the electric motor is stopped by the measures of the method according to the disclosure.

### Two Cases Can Occur

When the electric motor starts to rotate, the electric motor, which is actually speed-stable, still unintentionally rotates in the wrong direction. In this case, the electric motor comes to a standstill even before the software strategy for detecting the wrong direction of rotation, as devised in the disclosure, can carry out an evaluation, because monitoring routines to protect the system, which is inherently resistant to the direction of rotation, register this and at least stop the electric motor. If these monitoring routines are too slow or have failed, the electric motor is stopped by the measures of the method according to the disclosure. The rotational speed is therefore still low at this point and there will also be little pressure in the system.
A second case would be that the electric motor is still rotating in the right direction at a certain point in time. However, a short-term special situation (active short circuit, open terminals or anisotropy problem) can lead to an incorrect rotational direction being suddenly detected when the device is switched on again or spontaneously. However, the motor itself still rotates in the original, correct direction. In this case, it is important that the detection according to the disclosure takes place so quickly that the superimposed rotational speed controller has not yet made any major control interventions. According to the disclosure, the wrong rotational direction should be detected before the motor can reverse and a viable countermeasure, e.g., an active short circuit, should be initiated. Another measure would be to quickly close valves in the consumption path in order to keep the pressure in the hydraulic system for as long as possible.

FIG. 1 shows a situation where the electric motor is started from a standstill in a sensorless or controlled manner. It is clearly visible that the rotational speed is negative, although this may only be positive for the electric motor to behave correctly in the system. After the detection phase, a countermeasure can be initiated.

FIG. 1 shows angles of the sensorless method according to the disclosure and a speed direction sensor. In a real sensorless system, this would not be possible because there is neither a transmitter nor a sensor that receives the signals from the transmitter.

After a very short time, the error can be detected by evaluating the rotational speed signal and the malfunction can be reported to the higher-level software.

1. A method for operating a direction-of-rotation sensorless electric motor having a stator and a rotor, injected signals being used to determine rotational speeds of the electric motor, comprising:
determining the rotational direction of the electric motor implementing defined measures when an unwanted rotational direction is determined or if an unwanted rotational direction is mistakenly determined.

2. The method according to claim 1, wherein a desired rotational direction is determined when positive rotational speed values are determined.

3. The method according to claim 1, wherein an unwanted rotational direction is determined if negative speed values are present during a detection phase of defined duration and if the rotational speed values fall below a defined negative speed threshold during the detection phase.

4. The method according to claim 1, wherein the rotational direction of the electric motor is determined immediately after the occurrence of a special situation.

5. The method according to claim 1, wherein there is a special situation when an output stage of the electric motor is switched off or when an anisotropy problem occurs.

6. The method according to claim 1, wherein there is a special situation when a short circuit occurs or when an active short circuit occurs or when open terminals occur.

7. The method according to claim 1, wherein a defined measure is an active short circuit.

8. The method according to claim 1, wherein a defined measure is the defined closing of valves in a hydraulic system.

9. A method for operating a direction-of-rotation sensorless electric motor comprising:
injecting one or more signals into the electric motor;
determining, with the injected one or more signals, the rotational direction of the electric motor immediately after the occurrence of a special situation; and
implementing one or more defined measures when an unwanted rotational direction is determined or when an unwanted rotational direction is mistakenly determined,
wherein a defined measure comprises at least one of shorting a circuit or closing valves of a hydraulic system.

10. The method according to claim 9, wherein a desired rotational direction is determined when positive rotational speed values are determined.

11. The method according to claim 9, wherein an unwanted rotational direction is determined if negative speed values are present during a detection phase of defined duration and if the rotational speed values fall below a defined negative speed threshold during the detection phase.

12. The method according to claim 9, wherein the special situation comprises at least one of switching off of an output stage of the electric motor or occurrence of an anisotropy problem.

13. The method according to claim 9, wherein the special situation comprises at least one of an occurrence of a short circuit, an occurrence of an active short circuit, or occurrence of open terminals.

14. A controller configured to execute software instructions for operating a direction-of-rotation sensorless electric motor having a stator and a rotor, injected signals being used to determine rotational speeds of the electric motor, wherein the software instructions are configured to execute the steps comprising:
determining the rotational direction of the electric motor immediately after the occurrence of a special situation; and
implementing one or more defined measures when an unwanted rotational direction is determined or when an unwanted rotational direction is mistakenly determined,
wherein a defined measure comprises at least one of shorting a circuit or closing valves of a hydraulic system.

15. The controller according to claim 14, wherein a desired rotational direction is determined when positive rotational speed values are determined.

16. The controller according to claim 14, wherein an unwanted rotational direction is determined if negative speed values are present during a detection phase of defined duration and if the rotational speed values fall below a defined negative speed threshold during the detection phase.

17. The controller according to claim 14, wherein the special situation comprises at least one of switching off of an output stage of the electric motor or occurrence of an anisotropy problem.

18. The controller according to claim 14, wherein the special situation comprises at least one of an occurrence of a short circuit, an occurrence of an active short circuit, or occurrence of open terminals.
